(19) United States
(12) Patent Application Publication
(10) Pub. No.: US 2022/0292620 A1
(43) Pub. Date: Sep. 15, 2022

(54) FLOATING LICENSE COMPUTING SYSTEM AND METHOD FOR FOUNDRY PROCESS DESIGN KITS (PDKs)

(71) Applicant: Keysight Technologies, Inc., Santa Rosa, CA (US)

(72) Inventors: Ravi Kumar Verma, Haryana (IO); Kevin Dhawan, Haryana (IO); K Chan Basha, Karnataka (IO)

(21) Appl. No.: 17/200,397

(22) Filed: Mar. 12, 2021

(51) Int. Cl. G06Q 50/18; G06Q 10/10

(52) U.S. Cl. CPC G06Q 50/184; G06Q 10/10

(57) ABSTRACT

A system for managing process design kit (PDK) licenses among a plurality of Electronic Design Automation (EDA) workstations is provided. The system includes a PDK license server including N floating licenses, where N is a plural integer, and a plurality of EDA workstations each equipped with EDA software. The EDA software configured to enable a PDK license request mechanism for requesting a PDK license from the PDK license server. The license request mechanism is configured to deny grant of the PDK license when the EDA workstation is not connected to the PDK license server, and is further configured to automatically block a previously granted PDK license when connection to the PDK license server is interrupted.

### BACKGROUND

Accurate models both for active devices and for passive components are critical in semiconductor design. Without accurate models for simulation, it is almost impossible to produce a successful silicon/GaAs/GaN-based circuit. To facilitate modeling, the use of Process Design Kits (PDKs) has been adopted. A PDK is a set of component libraries and associated data used within the semiconductor industry to model a fabrication process for Electronic Design Automation (EDA) tools which are used to design an integrated circuit (IC). One example of an EDA tool is the Pathwave Advanced Design System (ADS) offered by Keysight Technologies. The PDK is created by the foundry defining a certain technology variation for their processes. It is then passed to their customers to use in the design process. The customers/designers use the PDK to design, simulate, draw, and verify the design before handing the design back to the foundry to produce the designed ICs.

The foundry PDKs contain intellectual property (IP) from the foundry, including proprietary process and manufacturing information. As such, foundries are generally concerned with this information being misused or misappropriated by unauthorized users. In an effort to protect foundry IP, a node-locked licensing mechanism has been used to manage access to PDKs. A node-locked license is characterized in part by licensing of PDKs to a single machine. If a licensed end-user were to change machines, it is necessary to transfer the license to the new machine. Foundries are thus limited to locking PDK access to the machine IDs of authorized users. This is very inconvenient, especially when the number of users is large and dynamic. Large customers using the existing node-locked license mechanism must approach the foundry repeatedly to have the list of their authorized users/machines updated, i.e., each time a user needs to be added/removed or the user's workstation changes. The result is an inefficient use of the computer resources of both the customer and the foundry.

### SUMMARY

According to an aspect of the inventive concepts, a system for managing process design kit (PDK) licenses among a plurality of Electronic Design Automation (EDA) workstations is provided. The system includes a PDK license server including N floating licenses, where N is a plural integer, and a plurality of EDA workstations each equipped with EDA software. The EDA software is configured to enable a PDK license request mechanism for requesting a PDK license from the PDK license server. The license request mechanism is configured to deny grant of the PDK license when the EDA workstation is not connected to the PDK license server, and is further configured to automatically block a previously granted PDK license when connection to the PDK license server is interrupted.

Each EDA workstation is configured to continuously monitor connectivity to the PDK license server, and to automatically block user access the previously granted PDK license when the connectivity is lost.

The PDK license server is responsive to a request for a PDK license to determine if any of the N floating licenses are available. When the PDK license server determines that none of the N floating licenses are available, the PDK license server is configured to check if any currently PDK licensed EDA workstations has disconnected from the PDK license server. The PDK license server will grant the request when it has been determined that a currently PDK licensed EDA workstation has disconnected from the PDK license server. The PDK license server denies the request when it has been determined that no currently PDK licensed EDA workstation has disconnected from the PDK license server.

A PDK use status configuration variable of each EDA workstation is updated each time a PDK license to the EDA workstation is granted or blocked. Likewise, a PDK user database of the PDK license server is updated each time a PDK license to an EDA workstation is granted or blocked.

A granted PDK license to an EDA workstation is released by updating a PDK use status configuration variable of the EDA workstation when the EDA software of the EDA workstation is exited or the EDA workstation is closed.

According to another aspect of the inventive concepts, a method for managing process design kit (PDK) licenses among a plurality of Electronic Design Automation (EDA) workstations. The method includes installing a PDK at an EDA workstation, and using EDA software including the PDK of the EDA workstation to request a license to use the PDK. The method further includes denying the request, at the EDA workstation, when the EDA workstation is not connected to a PDK license server. The method still further includes determining, at the PDK license server, whether a license for the PDK is available from among a pool of PDK licenses when the EDA workstation is connected to the PDK license server, and granting, from the PDK license server to the EDA workstation, the request for a license to use the PDK when it is determined that a license for the PDK is available from among a pool of PDK licenses. The method further includes checking, at the PDK license server when it is determined that a license for the PDK is not available from among a pool of PDK licenses, whether another EDA workstation having a current PDK license has disconnected from the PDK license server, and granting, from the PDK license server to the EDA workstation, the request for a license to use the PDK when it is determined the other EDA workstation having the current PDK license has disconnected from the PDK license server.

The method further includes continuously monitoring, at the EDA workstation, whether the connection to the PDK license server is terminated, and automatically blocking, at the EDA workstation, access to the PDK license when the connection of the EDA workstation to the PDK license server is terminated.

The method still further includes denying, from the PDK license server to the EDA workstation, the request when it has been determined that no currently PDK licensed EDA workstation has disconnected from the PDK license server.

The method further includes updating a PDK use status configuration variable of the EDA workstation each time a PDK license to the EDA workstation is granted or blocked. Also, the method includes updating a PDK user database of the PDK license server each time a PDK license to the EDA workstation is granted or blocked.

The method further includes blocking a previously granted PDK license to the EDA workstation by updating a PDK use status configuration variable of the EDA workstation when the EDA software of the EDA workstation is exited or the EDA workstation is closed.

### BRIEF DESCRIPTION OF THE DRAWINGS

The above and other aspects and features of the inventive concepts will become readily apparent from the detailed description that follows, with reference to the accompanying drawings, in which:

FIG. 1 is a schematic diagram showing a foundry and Electronic Design Automation (EDA) client entity in accordance with embodiments of the inventive concepts;

FIG. 2 is a flow diagram for reference in explaining an EDA user boot procedure in accordance with embodiments of the inventive concepts; and

FIG. 3 is a flow diagram for reference in explaining an EDA user unboot procedure in accordance with embodiments of the inventive concepts.

### DETAILED DESCRIPTION

Embodiments of the inventive concepts will now be described with reference to the accompanying drawings. Throughout the drawings, like reference numbers refer to the same or similar elements. Separately, as is traditional in the field of the inventive concepts, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the example embodiments. Further, the blocks, units and/or modules of the example embodiments may be physically combined into more complex blocks, units and/or modules without departing from the scope of the example embodiments.

The inventive concepts result in a floating licensing mechanism to control the usage of foundry Process Design Kits (PDKs) by Electronic Design Automation (EDA) users, while simultaneously overcoming the limitations of the node-locked PDK licensing approach described earlier. The inventive concepts at least in part provide an efficient use of computer resources of EDA client entities having a dynamic multi-user base of designers.

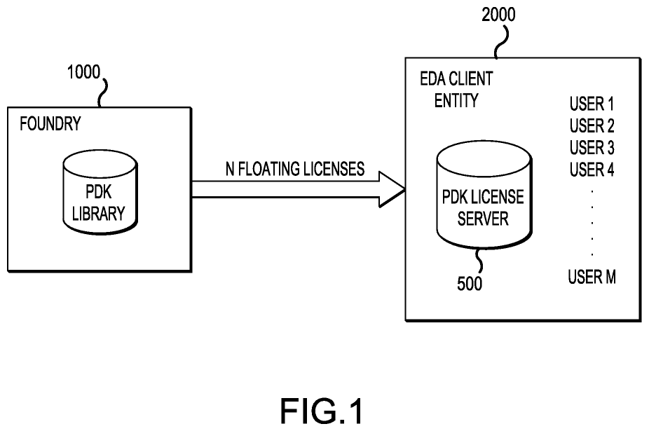

Attention is directed to the schematic diagram of FIG. 1. Shown in FIG. 1 are a foundry 1000 and an EDA client entity 2000. The EDA client entity 2000 is assumed to have M users or workstations that use EDA tools of the EDA client entity 2000. The foundry 1000 maintains a library of PDKs, and licenses its PDKs and provides a requested license pool (say N) for the client entity 2000 to host on their PDK license server 500. At any given point of time, without the need to disclose machine identifications (IDs) or other identification IDs, N users among the M users of the EDA client entity are authorized to use the licensed PDKs to create their designs in EDA software. As described in detail below, the PDK will not load on a user workstation without a valid license, and hence no user can access the foundry's PDK without its approval.

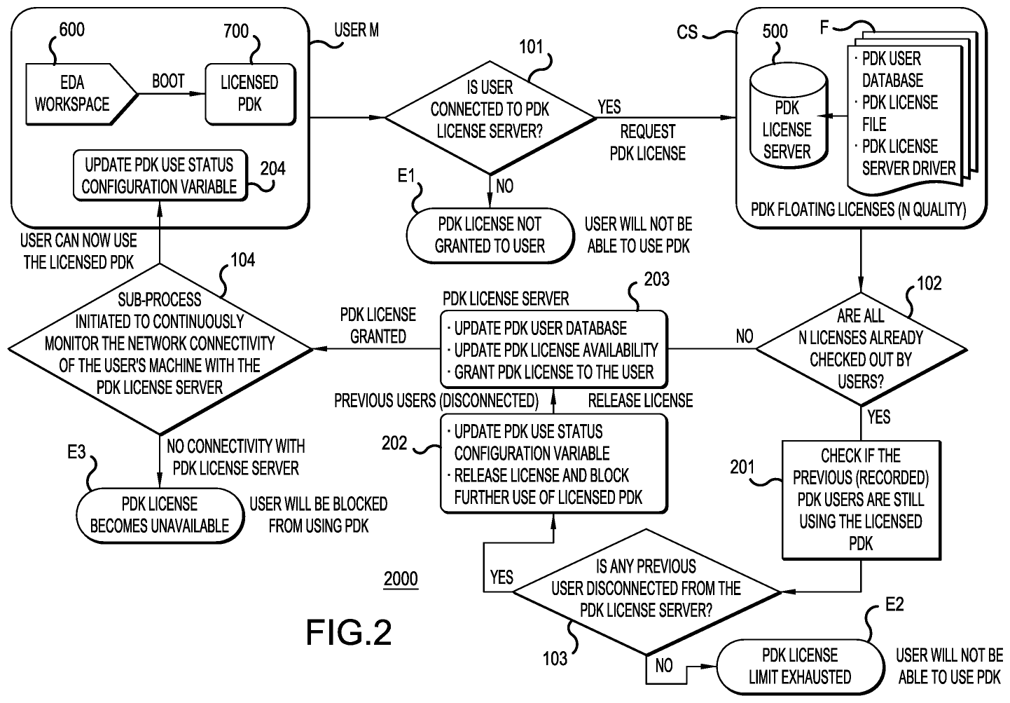

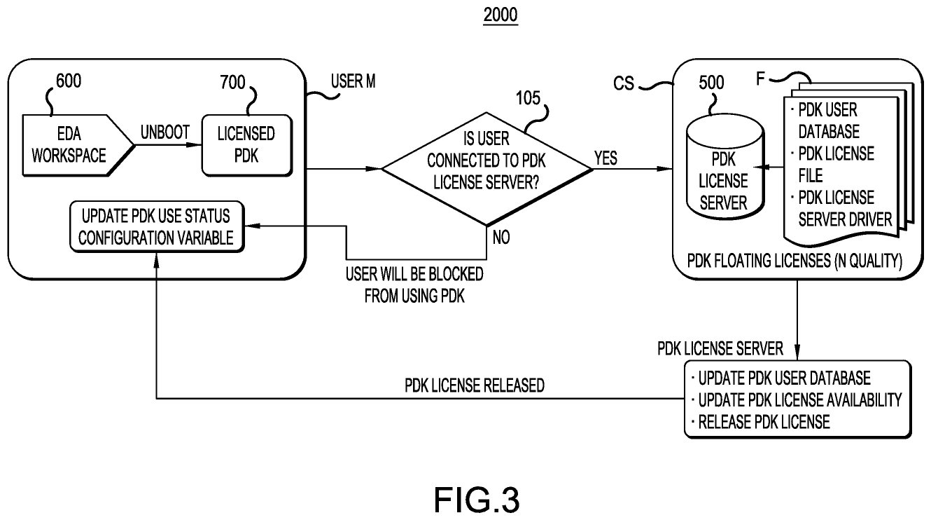

The overall flow of using floating PDK licenses from the PDK license server 500 can be divided into two broad operations, both of which require the user to be connected to the PDK license server at all times. The first is a Boot (install) operation for requesting a floating PDK license from among the pool of license managed by the PDK license server 500. The second is an UnBoot (remove) operation in which the user releases the PDK license to the PDK license server 500. These two operations are discussed in detail below with reference to FIGS. 2 and 3, respectively.

Attention is directed to the flow diagram of FIG. 2 for reference in describing a computer-implemented process that takes place when a licensed EDA PDK is added to an EDA user workspace according to an embodiment of the inventive concepts. This may be referred to as a Licensed PDK Boot procedure in which an EDA user requests a floating PDK license from the PDK license server 500 of the EDA client entity. The request may be made, for example, by prompting the use to locate (or browse for) a floating PDK license driver hosted on a central server at the customer end.

FIG. 2 schematically illustrates an EDA user Userₘ. Here, the subscript “m” denotes a user workstation among the 1 to M user workstations of the EDA client entity 2000 shown in FIG. 1. That is, the EDA client entity may be an organization with M user workstations having licensed access to EDA software creating a EDA workspace 600, as well as access to one or more foundry PDKs 700 for which a PDK license may be needed from time to time.

FIG. 2 also schematically illustrates a central server CS of the EDA client entity 2000 shown in FIG. 1. The central server CS includes the PDK license server 500. To implement the PDK license server 500, the EDA client entity 2000 may be provided with a number of files F from the foundry and/or the provider of the EDA software. In an example, the EDA provider (such as Keysight, mentioned previously) supplies the foundry 1000 with the files required by the foundry's customers (i.e., EDA client entities 2000) to setup a PDK license server 500, and then these files are supplied from the foundry 1000 to the EDA client entities 2000. The files may be compiled ael files and encrypted python files. Once installed, the files F associated with the PDK license server 500 may include one or more drivers, PDK licenses files, and so on.

It is noted here that files required by the foundry to license their PDKs may include the compiled ael and encrypted python files that are be part of the licensed PDKs that the foundry ships to its EDA client entities. In other words, in embodiments of the inventive concepts, the foundry PDK resident at the EDA user workstation includes a license install mechanism that is activated when accessed by an EDA workspace 600 (licensed EDA software package) of the EDA user workstation. That is, a previously mentioned “boot” (or install) of the foundry PDK is initiated in order for the workspace to gain access to the licensed foundry PDK.

Initially, the EDA user Userₘ of the PDK is prompted to locate (browse) the PDK license driver 500 hosted on the central server CS at the EDA client entity 2000. As shown at reference number 101 of FIG. 2, if the EDA user Userₘ is not connected to the PDK license server 500 (“No” at 101), the PDK license is not granted (denied) at E1 of FIG. 2. This denial of access is implemented at the user workstation by software resident in the PDK and/or EDA.

On the other hand, in the case where the license driver is located (“Yes” at 101) by the EDA workspace 600, a process is initiated at the license server 500 to check if all (N) licenses hosted by the EDA client entity 2000 are in use by other users (102 of FIG. 2). For purposes of explanation, it is assumed that the EDA client entity has access to N floating licenses. Here, N may be the same as, less than, or more than the previously described number M of user workstations.

Referring to FIG. 2, if a PDK License is available (“No” at 102), the PDK license server 500 executes process shown at 203 to pass the available license to the requesting user Userₘ. These processes include updating the PDK User Database to record usage data associated with the requesting user, and updating the availability status of the license as not-available. In addition, the license server transmits code to the EDA software of the user workstation which grants the requested license, thus enabling use of the PDK by the EDA workspace 600.

On the other hand, if one of the N floating licenses is not available (“Yes” at 102), the PDK license server 500 at 201 of FIG. 2 checks (or tracks in real-time) to see if all currently recorded PDK users are still using their licensed PDKs. This may be accomplished, for example, by determining if any current PDK licensed user is disconnected from the PDK license server 500. If no current PDK license user has disconnected from the PDK license server 500 (“No” at 103), the PDK license requested by the EDA user Userₘ is denied (not granted) since the PDK license limit (N) is exhausted (E2 of FIG. 2).

If a PDK license user has disconnected from the PDK license server 500 (“Yes” at 103), then a disconnect process shown at 202 of FIG. 2 will have been carried out at the EDA workspace of the user workstation. Namely, for example, a PDK use status configuration variable may be updated to reflect that the license is no longer being used, and the license may be released and further use of the license may be blocked by the EDA workspace 600 of the disconnected user. If the user workstation again desires a license for the PDK, the process described so far above is repeated.

Once the license is released by the EDA workspace 600, the PDK license server 500 executes the previously described process shown at 203 to pass the newly available license to the requesting user. These processes include updating the PDK User Database to record usage data associated with the requesting user, and updating the availability status of the license as not-available. In addition, the license server transmits code to the EDA software of the user workstation which grants the requested license, thus enabling use of the PDK by the EDA workspace 600.

Once the PDK License is granted to the user, the PDK Use Status Configuration Variable is updated on the user's workstation (204 of FIG. 2). Additionally, throughout a time period during which the PDK license is granted to the user workstation, a sub-process (104 of FIG. 2) of the PDK and/or EDA is carried out to continuously monitor network connectivity of the user workstation with the PDK license server. If the connectivity is lost, further usage of the PDK is blocked (E3 of FIG. 2) and the user is prompted to either reconnect back to the server or save his/her designs and exit.

In the entire operation described above in connection with FIG. 2, the PDK user only needs to browse to the PDK License file location, and the rest of the operation is handled automatically using, for example, AEL, Python, Shell, and Batch programs.

As described above, the PDK license will be released to the server in two cases. One case is when the PDK user is still connected to the PDK License Server and he/she closes his/her workspace or exits the EDA software, the licensed EDA PDK is no longer being used and a PDK license becomes available at the server end. The corresponding user's information is updated in the PDK License database file at the server end, while the PDK User Status Configuration variable is updated on the user' s machine.

The other case in which PDK license will be released to the server 500 is if the user's machine is not connected to the PDK license server 500 at any point in time. In that case, the PDK User Status Configuration variable is updated on the user's machine and the user will be blocked from further using the licensed EDA PDK until his/her connection with the PDK license server 500 is re-established. The corresponding availability of the license will be updated at the server end when a new PDK user requests a PDK license from the PDK license server 500. This will be handled as per the PDK boot (install) operation described above in connection with FIG. 2.

Reference is now made to the flow diagram of FIG. 3 for reference in describing the previously mentioned “UnBoot” process of the PDK license from the user's workstation. Like the PDK boot process, this operation may also be achieved automatically using AEL, Python, Shell and Batch programs. Like elements of FIG. 3 that are the same as or similar to those of FIG. 2 are identified by the same references, and a detailed description of such elements is omitted here to avoid redundancy in the description.

Referring to FIG. 3, when the PDK user Userₘ is still connected to the PDK license Server (“Yes” at 105) and closes his workspace or exits the EDA software, the licensed PDK is no longer being used and a PDK License becomes available at the server end. The corresponding user's information is updated in the PDK license database file at the server end, and PDK User Status Configuration variable is updated on the user's machine. On the other hand, if the user's machine is not connected to the PDK license server 500 at any point in time (“No” at 105), the PDK User Status Configuration variable is updated on the user's machine and the user will be blocked from further using the licensed PDK until his connection with the PDK license server 500 is re-established. The corresponding availability of license will be updated at the server end when a new PDK user makes a requests for PDK license from the PDK license server. This may be handled as per the PDK boot (install) operation.

The inventive concepts described above provide a secure mechanism to deliver PDK licenses to EDA client entities in bulk. Further, the need to generate individual licenses (linked to machine IDs) is eliminated, which is cumbersome and error-prone when the number of authorized users is large. The inventive concepts may be especially useful in large organizations where the user-base is dynamic. The EDA client entity no longer needs to repeatedly contact the foundry for licenses, which improves computer resource efficiency and the foundry's efficiency as well.

While the inventive concepts have been illustrated and described in detail in the drawings and foregoing description, such illustration and description are to be considered illustrative or exemplary and not restrictive; the inventive concepts are not limited to the disclosed embodiments. Other variations to the disclosed embodiments can be understood and effected by those skilled in the art in practicing the claimed invention, from a study of the drawings, the disclosure, and the appended claims. While representative embodiments are disclosed herein, one of ordinary skill in the art appreciates that many variations that are in accordance with the present teachings are possible and remain within the scope of the appended claim set. The inventive concepts therefore are not to be restricted except within the scope of the appended claims.

What is claimed is:

1. A system for managing process design kit (PDK) licenses among a plurality of electronic design automation (EDA) workstations, the system comprising:
a PDK license server including N floating licenses, where N is a plural integer; and
a plurality of EDA workstations each equipped with EDA software, the EDA software configured to enable a PDK license request mechanism for requesting a PDK license from the PDK license server;
wherein the license request mechanism is configured to deny grant of the PDK license when the EDA workstation is not connected to the PDK license server, and is further configured to automatically block a previously granted PDK license when connection to the PDK license server is interrupted.

2. The system of claim 1, wherein each EDA workstation is configured to continuously monitor connectivity to the PDK license server, and to automatically block user access the previously granted PDK license when the connectivity is lost.

3. The system of claim 1, wherein the PDK license server is responsive to a request for a PDK license to determine if any of the N floating licenses are available.

4. The system of claim 3, wherein when the PDK license server determines that none of the N floating licenses are available, the PDK license server is configured to check if any currently PDK licensed EDA workstations has disconnected from the PDK license server.

5. The system of claim 4, wherein the PDK license server grants the request when it has been determined that a currently PDK licensed EDA workstation has disconnected from the PDK license server.

6. The system of claim 5, wherein the PDK license server denies the request when it has been determined that no currently PDK licensed EDA workstation has disconnected from the PDK license server.

7. The system of claim 1, wherein a PDK use status configuration variable of each EDA workstation is updated each time a PDK license to the EDA workstation is granted or blocked or released.

8. The system of claim 1, wherein a PDK user database of the PDK license server is updated each time a PDK license to an EDA workstation is granted or released.

9. The system of claim 1, wherein a granted PDK license to an EDA workstation is released by updating a PDK use status configuration variable of the EDA workstation when the EDA workspace is closed, or EDA software of the EDA workstation is exited or the EDA workstation is closed.

10. A method for managing process design kit (PDK) licenses among a plurality of electronic design automation (EDA) workstations, the method comprising:
installing a PDK at an EDA workstation;
using EDA software including the PDK of the EDA workstation to request a license to use the PDK;
denying the request, at the EDA workstation, when the EDA workstation is not connected to a PDK license server;
determining, at the PDK license server, whether a license for the PDK is available from among a pool of PDK licenses when the EDA workstation is connected to the PDK license server;
granting, from the PDK license server to the EDA workstation, the request for a license to use the PDK when it is determined that a license for the PDK is available from among a pool of PDK licenses;
checking, at the PDK license server when it is determined that a license for the PDK is not available from among a pool of PDK licenses, whether another EDA workstation having a current PDK license has disconnected from the PDK license server; and
granting, from the PDK license server to the EDA workstation, the request for a license to use the PDK when it is determined the other EDA workstation having the current PDK license has disconnected from the PDK license server.

11. The method of claim 10, further comprising:
continuously monitoring, at the EDA workstation, whether the connection to the PDK license server is terminated.

12. The method of claim 11, further comprising:
automatically blocking, at the EDA workstation, access to the PDK license when the connection of the EDA workstation to the PDK license server is terminated.

13. The method of claim 10, further comprising denying, from the PDK license server to the EDA workstation, the request when it has been determined that no currently PDK licensed EDA workstation has disconnected from the PDK license server.

14. The method of claim 10, further comprising updating a PDK use status configuration variable of the EDA workstation each time a PDK license to the EDA workstation is granted or blocked or released.

15. The method of claim 10, further comprising updating a PDK user database of the PDK license server each time a PDK license to the EDA workstation is granted or released.

16. The method of claim 10, further comprising blocking a previously granted PDK license to the EDA workstation by updating a PDK use status configuration variable of the EDA workstation when the EDA workspace is closed, or EDA software of the EDA workstation is exited or the EDA workstation is closed.
